(19) United States
(12) Patent Application Publication
(10) Pub. No.: US 2006/0253054 A1
(43) Pub. Date: Nov. 9, 2006

(54) Back Scratcher with triangular rake-like head

(76) Inventor: Jonathan P. Wright, South Ogden, UT (US)

Correspondence Address: Jonathan P. Wright, 5883 South 1325 East, South Ogden, UT, 84405, US

(21) Appl. No.: 10/908,344

(22) Filed: May 9, 2005

(51) Int. Cl. A61H 7/00

(52) U.S. Cl. 601/137

(57) ABSTRACT

A back scratcher, including an elongated handle with an open end for gripping and a closed end inserted into a polypropylene or other light weight plastic head offering rigidity, flexibility, light weight and relatively low cost, and resembling in general appearance a poly leaf or shrub rake. The head is in a triangular shape and has a base from which extends individual, flexible, reinforced tines of a sufficient length to allow movement—particularly horizontally—when used in an upright position. Each tine can move independently of the other tines thus allowing the device to conform to the natural contours of a back and facilitating the even distribution of exerted pressure on the recipient's back.

This invention relates to back scratchers. As long as there have been backs, there has been a need for back scratching. Certain trees serve the purpose well but they are not always conveniently close by and lack portability. It is also difficult if not impossible to reach all the potentially itchy areas of one's own back without the aid of a back scratching device. In the opinion of the applicant, the ultimate back scratching experience is realized by the kind contribution of a second person, skilled in the art, and using both hands simultaneously, as if connected at the wrist. (This is the preferred method this invention attempts to mimic). However, such a benefactor is not always readily accessible, willing or able to perform such a service. For these reasons, handheld or mechanical back scratching devices were created and have brought much relief to their users. The most pertinent of these devices are represented by U.S. Pat. No. 6,221,034 for its flexible toothbrush-like bristles, D311,605 reflective of scratchers with a rigid spike or spikes, and U.S. Pat. No. 5,904,661 for its small pivoting head. Also known to applicant are the following: U.S. Pat. No. 6,110,132 which mounts on an outside corner of an interior wall, D392,424 resembling building blocks on sticks, D330,094 resembling a small triangle on the end of a pole, D312,145 shaped like a bent ice pick, D4,574,788 resembling a scrub brush with a bent head, D266,280 a flat stick with a scratch pad, and D0,260,694 a chess piece-like scratcher.

Additionally known to applicant are references teaching related inventions in lawn and garden leaf rakes including D233,305 a 1974 patent for a poly rake head, U.S. Pat. No. 3,707,835 a design with long tines, U.S. Pat. No. 4,215,528 having a plastic molded head, and D248,612 a one-piece molded plastic head with long tines.

A thorough review of the prior art demonstrates the differences in the present device as a back scratcher in its use of long, independent (free floating on the open end), flexible tines formed in a rake-like shape allowing a significantly increased contact area and improved conformity to the natural contours of the human back. Nothing known to applicant in the prior art teaches the unique combination of features and structural parameters of applicants invention.

The specific problems involved in the prior art deal with the limited area of contact and the lack of flexibility across the contact area, resulting in uneven distribution of scratching pressure—thus over—scratching high areas and missing low areas of the back. The applicant's invention also allows the user to cover a large surface area with each stroke thus saving energy and time and bringing faster relief to one's itchy back. In sum, from observation of the present invention and the prior art, it can be shown that a single stroke with this invention covers a substantially greater area and because of the independent, floating tines, does so more effectively.

### SUMMARY OF THE INVENTION

This back scratcher has the basic appearance of a small (by leaf rake standards), handheld poly leaf rake. Yet by back scratcher standards, the rake head and consequent “swath” is quite large. The elements of the invention solve problems found in the prior art such as the absence of a wide contact area fanning out from a narrow, ergonomically-sized handle and the lack of a method producing even pressure distribution over a broad area. The present invention substantially improves the utility of such devices by offering a wide contact area—while maintaining a narrow handle—consisting of independently “floating” tines that encourage the even distribution of pressure over the naturally uneven surface of the back in ways unattainable in the methods previously taught.

### OBJECT OF THE INVENTION

It is therefore the object of this invention to introduce a back scratching device that for a relatively low cost duplicates a two-handed, ten-fingered back scratching experience.

It is yet another object of this invention to provide a back scratcher that has the general appearance of a small handheld leaf or shrub rake with a triangular-shaped head made of polypropylene or other light weight material.

It is yet another object of this invention to provide a head on the back scratcher that offers reinforced and rigid tines that are capable of movement independent of each other thus facilitating even pressure distribution and allowing contouring to individual back shapes.

### BRIEF DESCRIPTION OF THE DRAWINGS

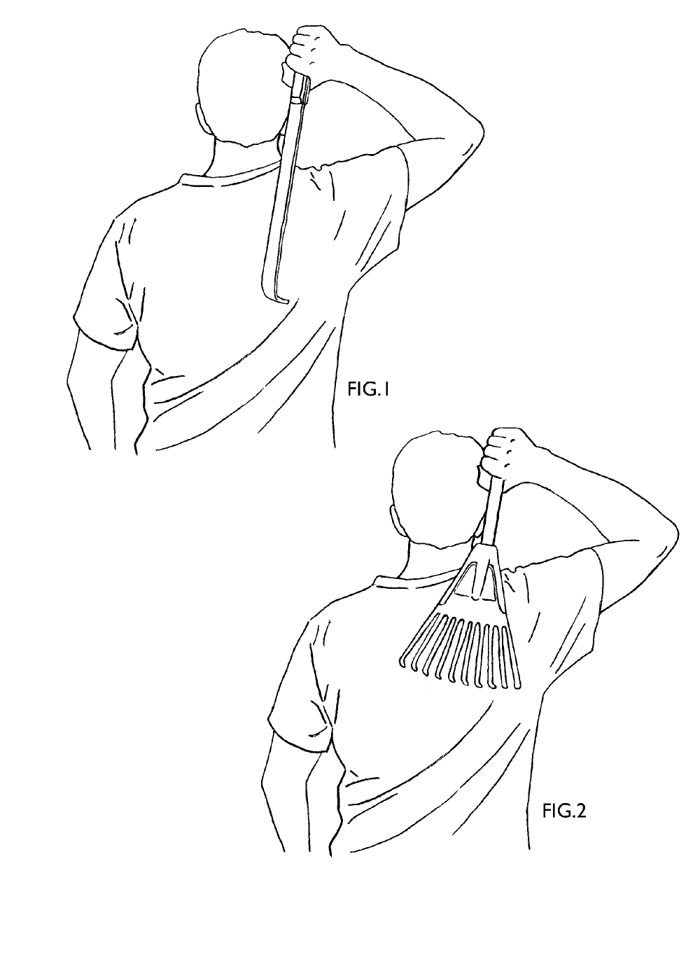

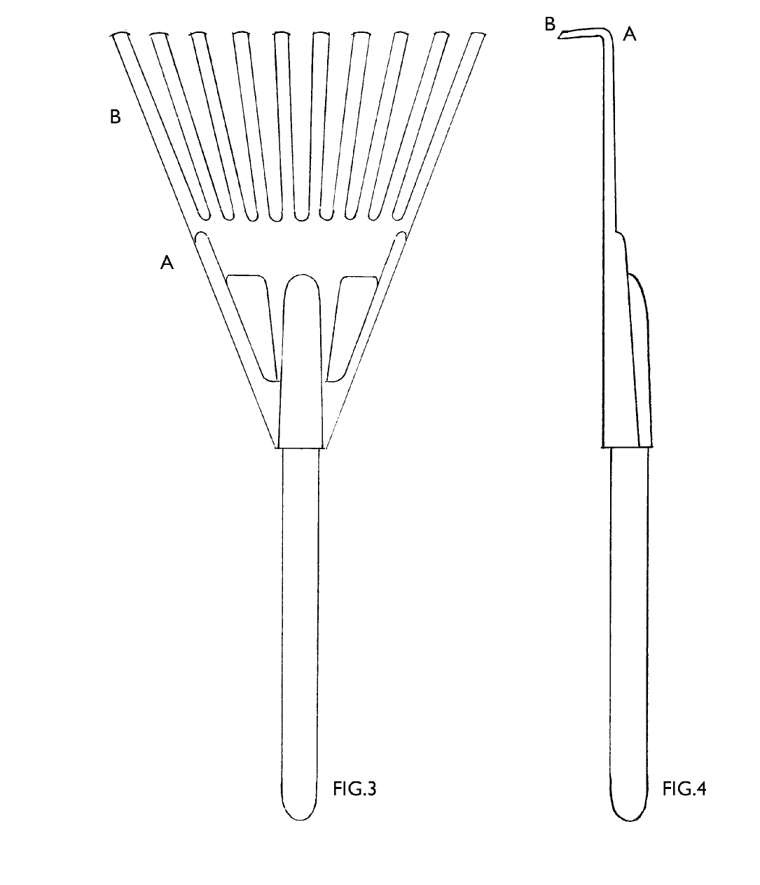

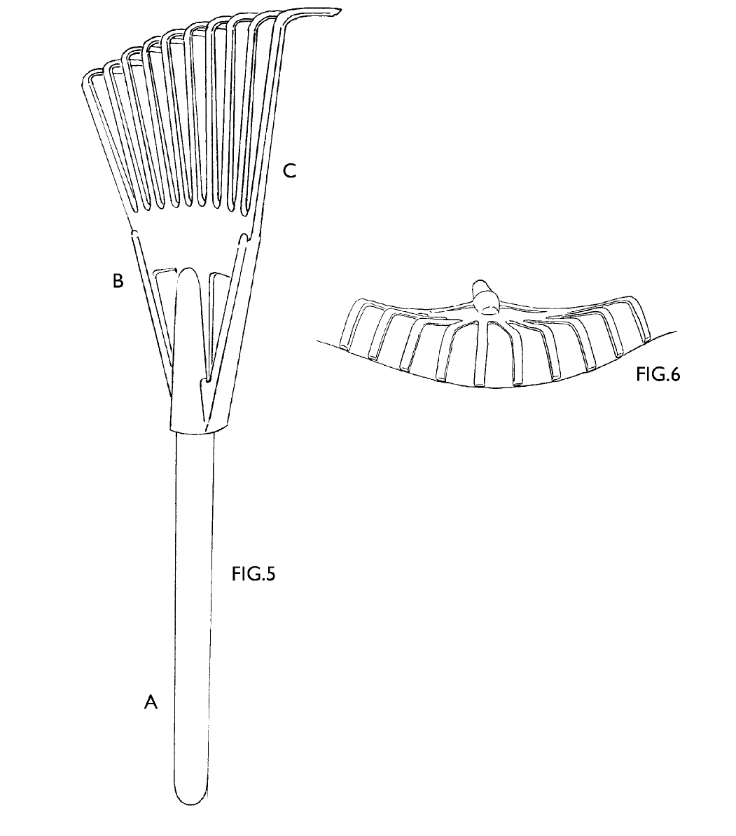

The handle, which ranges in size from 6-24 inches in exposed length, has an open end for grasping FIG. 5A and a closed end on which the head is attached FIG. 5B. The head is constructed ideally of molded polypropylene high impact plastic in a triangular shape FIG. 3A. The head is fashioned such that multiple tines extend upward from the base of the head FIG. 5C then make a uniform 90° turn an inch or so from the end FIG. 4A to create the abrasive edge of the head. The tines are individually reinforced to encourage rigidity but are not laterally connected above the base or near the end FIG. 3B, (as typically found on leaf rakes designed for a different purpose), so that each tine can “float” independently over the natural contours of the back FIG. 6, thus duplicating the independence of human fingers bent to form roughly a 90° angle which can flow naturally and accommodatingly over a recipient's back. Further, the tines are pointed at the end 4B to create an edge with a level of abrasion not unlike adequately sharp fingernails. By back scratcher standards, at 4-8 inches in width, the device is large, and will improve the quality of the back scratching experience through the even distribution of pressure FIG. 6 across a large contact area FIG. 2 because of the independently floating tines, and will improve efficiency, both of which are lacking in prior art FIG. 1.

While the invention at hand has been described in its preferred embodiment, it is understood that departures may be made there from within the scope of the invention, and therefore should not be limited to the details and description disclosed herein. The invention is to be afforded the full scope of claims to cover various modifications and materials contemplated in the future.

### BRIEF DESCRIPTION OF THE SEVERAL VIEWS OF THE DRAWINGS

FIG. 1 is a pictorial view of a person using a prior art back scratcher.

FIG. 2 is a pictorial view of a person using the present invention.

FIG. 3 is a front elevation view of the preferred embodiment of the present invention.

FIG. 4 is a side elevation view of the present invention.

FIG. 5 is a perspective view of the preferred embodiment.

FIG. 6 is a bird's eye view of the contouring effect of the preferred embodiment of the present invention.

What is claimed is:

1. I claim a back scratcher comprising:
an elongated handle with an open end for gripping and a closed end inserted into a head designed for scratching;
said head having a base from which independent, flexible, reinforced tines extend upward sufficiently from the base to allow each tine to move independently, more particularly in horizontal directions relative to a vertically-oriented (upright) subject;
said tines extending upward from the base and bending forward at approximately a 90° angle, and sufficiently pointed on the end to create an abrasive edge on the head.

2. A back scratcher as set forth in claim 1 wherein
the shape of the head is generally triangular and resembles the general proportions of a rake intended to rake leaves commonly referred to as a poly leaf or shrub rake;
said head being constructed of molded polypropylene high impact plastic or other lightweight material, offering rigidity, flexibility, and relatively low cost.
